(19) United States
(12) Patent Application Publication
(10) Pub. No.: US 2004/0029587 A1
(43) Pub. Date: Feb. 12, 2004

(54) Method for supporting a handover between radio access networks

(75) Inventors: Tony Hulkkonen, Helsinki (FI); Juha Back, Helsinki (FI)

Correspondence Address: COHEN, PONTANI, LIEBERMAN & PAVANE, 551 FIFTH AVENUE, SUITE 1210, NEW YORK, NY, 10176, US

(73) Assignee: Nokia Corporation, Espoo (FI)

(21) Appl. No.: 10/296,086

(22) PCT Filed: Mar. 30, 2001
(86) PCT No.: PCT/EP01/03653

(51) Int. Cl. H04Q 7/20

(52) U.S. Cl. 455/436

(57) ABSTRACT

The invention relates to a method for supporting a handover of a user equipment (15) from a first radio access network (11) to a second radio access network (13). In order to ensure the success of the handover, it is proposed that a core network stores at least for some user equipment (15) a list identifying all radio access networks, (11, 13) to which the respective user equipment (15) is allowed to be handed over. The core network can then transmit the information stored for a specific user equipment (15) to the first radio access network (11) (step c), so the first radio access network (11) can determine reliably before carrying out a handover by which other radio access network (13) a handover will be accepted. The invention equally relates to a core network, a network element of a core network and a network element of a radio access network that are designed for carrying out the proposed method.

### FIELD OF THE INVENTION

The invention relates to a method for supporting a handover of a user equipment from a first radio access network to a second radio access network. The invention equally relates to a core network for a communications system, a network element for a core network and a network element for a radio access network.

### BACKGROUND OF THE INVENTION

In mobile communications systems, radio access networks provide user equipment with a radio access for mobile communication. Each radio access network is further connected to a core network via which a user equipment can be connected with a radio access network of the same mobile communications system or with an element of another communications systems, depending on the desired connection. The term user equipment is used for any mobile terminal with a one or more subscriber identity modules, like a GSM (Global System for Mobile Communications) SIM (Subscriber Identity Module) or a UMTS (Universal Mobile Telecommunications System) USIMs (UMTS Subscriber Identity Module).

When a user equipment connected to a first radio access network is to be handed over for some reason to a second radio access network, the first radio access network has to select this second radio access network. Such a handover may become necessary for a variety of reasons. For example, the user equipment might move out of the serving area of the first radio access network, there might not be enough capacity for the first radio access network any more, the requested service can possibly not be provided by the first radio access network, or the subscriber might moves too fast, etc.

In case the user equipment is handed over to a radio access network which does not support an access by this user equipment, the established connection might be disrupted. A core network may not allow an access by the subscriber using this user equipment to the radio access network to which the user equipment is to be handed over, because the subscriber is of a wrong type, e.g. a GSM subscriber when only UMTS subscribers are allowed. Moreover, the currently ongoing service may not be supported in the target network, etc.

Further reasons for potential disrupts in an handover are given, when a user equipment is subscribed with a mobile virtual network operator (MVNO) and not directly with a regular mobile operator.

A MVNO is a mobile telecommunications operator who provides wireless services to subscribers under its own brand without owning any radio license or radio access infrastructure. An MVNO rather relies on regular mobile operators for radio resources and possibly for other network subsystems.

Depending on the kind of agreements between an MVNO and a regular mobile operator, there exists a variety of options for sharing the infrastructure of the regular network operator. The term MVNO neither implies a precise network architecture nor a commitment to a particular set of standard system components. For a minimal implementation, a MVNO may outsource the majority of its operation on to the host network operator and simply receive the billing information pertinent to its customers from the host network operator. At the other extreme, subscribers of an MVNO share only the access to the radio interface. In this case, the MVNO interconnects the radio access network by duplicating the remaining network functions and customising them for its particular service offerings. The agreement between MVNO and regular network operator could for example also include that when subscribers of the MVNO roam in the network of the regular network operator and an inter PLMN (public land mobile network) handover has to be made, the subscribers should be preferably handed over to one of different specified networks. The visited operator then configures the network equipment to support this requirement.

Examples of MVNOs are“Virgin Mobile” in the United Kingdom and“Sense” in Norway.

In case a subscriber to such an MVNO is involved in an handover, it depends at least on two different factors which of the available other radio access networks would actually accept a handover of a user equipment of a subscriber with an MVNO. First, it has to be technically possible to perform a handover from the serving radio access network to the target radio access network. And second, it depends on the roaming agreement between the operator of the visited network and the operator of the subscriber. Accordingly, additional reasons for a potential disrupt of a connection during a handover of a MVNO subscriber are that e.g. the target network does not have a roaming agreement with a users home network, or that other roaming restrictions exist, in which case the connection may, but does not necessarily disrupt.

FIG. 1 shows an example situation in which a problem during a handover in which a user equipment subscribed with an MVNO is involved may occur. In the figure, three radio access networks are depicted. The first radio access network 11 is a UMTS radio access network of a first public land mobile network PLMN 1 owned by a first network operator A. The second radio access network 12 is a GSM radio access network of said first PLMN 1 owned by said first network operator A. The third radio access network 13, finally, is a GSM radio access network of a second public land mobile network PLMN 2 owned by a second network operator B.

Further depicted in the situation of FIG. 1 is a first user equipment 14 subscribed with the first network operator A, and a second user equipment 15 subscribed with a MVNO.

Based on agreements with the first network operator A and the second network operator B, the MVNO makes use of the first and the third radio access network 11, 13 for supplying radio access to its subscribers. The respective international mobile subscriber identity (IMSI) of the subscribers of the MVNO is allocated from the IMSI range of the first or the second network operator A, B. Equally, the subscribers of the MVNO use as part of their identification a mobile country code (MCC) and a mobile network code (MNC) identifying one of the radio access networks 11, 13 they are allowed to access.

Now, both user equipments 14, 15 in FIG. 1 are to be handed over to another radio access network, since they are for example moving out of the serving area of the first radio access network 11. The first radio access network 11 therefore has to decide which user equipment is to be handed over to which of the other radio access networks 12, 13.

Technically it would be possible to hand over both of the user equipments 14, 15 to either of the other two radio access networks 12, 13. But since the first user equipment 14 is only subscribed with the first network operator 1 and since the second user equipment is subscribed only with the MVNO, the first user equipment 14 can only be handed over successfully to the second radio access network 12 and the second user equipment 15 can only be handed over successfully to the third radio access network 13. For the first user equipment 14 subscribed with the first network operator A, the first radio access network 11 has a default information indicating to which other radio access network 12 the user equipment 14 is preferably to be handed over. However, it is not possible for the radio access network 11 to know that the target radio access network 12 is not applicable for the second user equipment 15, and that rather target radio access network 13 should be chosen for this user equipment 15. In case the first radio access network 11 selects the wrong target radio access network for the handover of the second user equipment 15, the connection of the second user equipment 15 will be disrupted.

The same problem can occur in several other situations in which a user equipment subscribed with an MVNO is involved.

Also without the involvement of an MVNO subscribed user equipment a similar problem can occur, e.g. in the handover of international roamers in country border areas. In such a scenario, a foreign network operator providing service for an international roamer should hand over the roamer to the subscribers home network when the roamer moves back into the serving area of the subscribers home network. On the other hand, a network operator having a co-operation agreement with a foreign network operator is interested in handing over a subscriber crossing the boarder to a radio access network of exactly this business partner.

Also networks shared by different owners might lead to a similar problem. UMTS licence holders, for example, are looking for ways to decrease the amount of initial investment needed to build their networks by sharing common networks. In the coverage of a shared UMTS network, there are again two or more possible target networks and the correct target network has to be selected when a handover takes place, or the call may be lost.

### SUMMARY OF THE INVENTION

It is an object of the invention to ensure the success of a handover from a first radio network to a preferred second radio access network.

This object is reached on the one hand with a method for supporting a handover of a user equipment from a first radio access network to a second radio access network, wherein a core network to which the first radio access network is connected transmits information stored in said core network to the first radio access network, which information indicates to which radio access networks the user equipment is permitted to be handed over.

On the other hand, the object is reached with a core network of a communications system comprising storing means for storing for at least one user equipment or for at least one group of user equipments information indicating to which radio access networks a respective user equipment is permitted to be handed over. Moreover, the core network according to the invention comprises transmitting means for transmitting said information stored for a specific user equipment or for a specific group of user equipments to a radio access network to which said specific user equipment or a member of said specific group of user equipments is currently connected or to which said specific user equipment or said member of said specific group of user equipments is currently establishing a connection. The object is also reached with a network element for a core network of a communications system comprising these features. A group of user equipment may be a specified category of user equipments, e.g. subscribers of particular network.

Finally, the object is equally reached with a network element for a radio access network of a communications system comprising receiving means for receiving information indicating for a user equipment currently connected to said network element or currently establishing a connection to said network element to which radio access networks said user equipment is permitted to be handed over. The network element comprises in addition selecting means for selecting a network element of another radio access network for a handover of said user equipment to a network element of another radio access network according to information received by said receiving means for said user equipment.

The invention proceeds from the idea that for ensuring a successful handover of a user equipment currently connected to a first radio access network to some other radio access network, the first radio access network should know which other radio access networks will accept a handover of this user equipment. To this end, the first radio access network has to be provided with the relevant information. Since the core network of a PLMN has knowledge about roaming agreements with the operators of other networks, it is suited best to store such information and to provide it whenever necessary to the first radio access network. The information has to be present in the first radio access network at the latest before a handover of a connected user equipment. On the other hand it cannot be provided before the core network knows that a user equipment wants to establish a connection with the first radio access network.

Preferred embodiments of the invention become apparent from the subclaims.

The information is preferably transmitted from the core network to the first radio access network during the establishment of a connection between said user equipment and said core network via said first radio access network. This has the advantage that the information is immediately available in the first radio access network when another radio access network has to be selected for a handover. The information is transmitted in particular after authentication of said user equipment with said core network. The authentication procedure provides the core network with the IMSI of the user equipment, and from this point of time the core network can select the information stored for said user equipment for transmission.

Preferably, said information is in addition transmitted from said core network to said first radio access network during handover signalling transmitted for handing over said user equipment from a first network element of said first radio access network to a second network element of said first radio access network. This way, the information will also present after a handover of a user equipment within the same radio access network.

Each radio access network can be clearly identified with the combination of the MCC and the MNC that were assigned to the respective radio access network. The transmitted information therefore preferably comprises the MCC and MNC of each radio access network to which said user equipment is permitted to be handed over.

Advantageously, the information does not only indicate to which radio access networks a handover is allowed, but also the order in which these radio access networks are preferably selected by the first radio access network.

The information is preferably provided to the core network by the operator of a communications system to which said core network belongs. Advantageously, the information does not have to be stored for each user equipment that can be served by the core network, but only for those selected by the network operator. Moreover, there may be multiple sets of information about allowed target networks, and each set is applied to a particular group of users. Thus, the default information in the radio access networks can e.g. further be used for those user equipments for which the core network does not indicate any preferred target networks. Also the transmission of the information can be optional, the core network determining first for each user equipment, whether said stored information is to be transmitted or not.

The network element of the invention can be or comprises in particular an SGSN (Serving General Packet Radio System Support Node), like a 2G/3G (second generation / third generation) SGSN, and/or an MSC/VLR (Mobile Services Switching Centre / Visitor Location Register) and/or an MSC server introduced in 3GGP Release 4 for a core network of a communications system. Information stored in the SGSN of a packet switched core network and information stored in an MSC/VLR of a circuit switched core network can be supplied to UMTS or GSM radio access networks. The network element of the invention can be in particular a UMTS RNC (Radio Network Controller) or a GSM BSC (Base Station Controller) for a radio access network of a communications system. In a PLMN, the features are preferably implemented in all SGSNs, MSC/VLRs, UMTS RNCs and GSM BSCs of the PLMN.

The invention is of particular advantage, if the user equipment is subscribed to a mobile virtual network operator and not to a regular network operator, since in this case the subscribers identity does not necessarily provide information about subscriber's service provider. Thus the first radio access network is not able to select reliably an allowed target radio access network for a handover. Equally, the invention is of advantage in country border areas for supporting a handover of international roamers and in networks shared by several owners.

The invention is applicable in all mobile networks which support handover between different radio access networks.

### BRIEF DESCRIPTION OF THE FIGURES

In the following, the invention is explained in more detail with reference to drawings, of which

FIG. 1 shows a scenario with different handover possibilities; and

FIG. 2 illustrates the signalling for an embodiment of the method according to the invention.

### DETAILED DESCRIPTION OF THE INVENTION

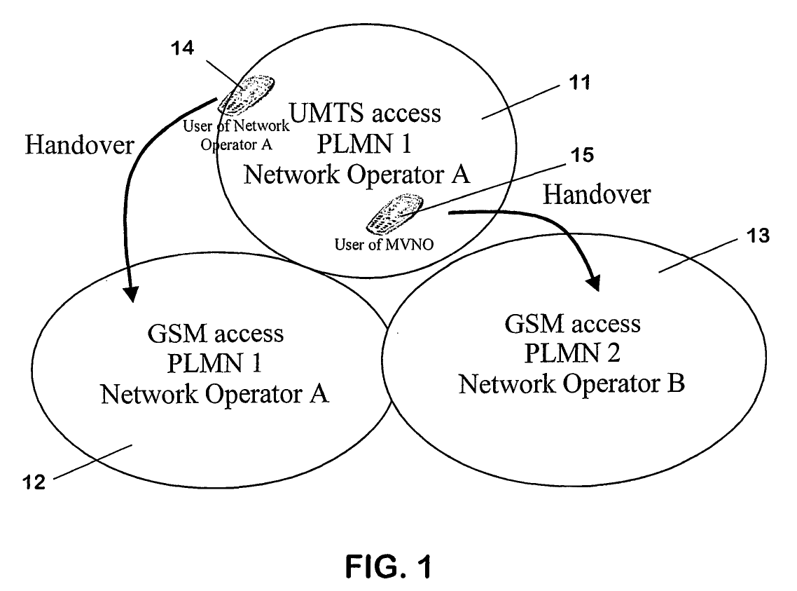

FIG. 1 has already been described with reference to the background of the invention.

A user equipment can access a PLMN via different radio access networks. The embodiments of the method of the invention described in the following include different possibilities of implementing the method of the invention for different kinds of access.

A user equipment can access a PLMN for example via a node B of a UMTS radio access network. Each node B is connected to an RNC of the radio access network. The RNC of a UMTS Radio Access Network is further connected via an Iu interface to an MSC/VLR of a circuit switched core network or via an Iu interface to an SGSN of a packet switched core network.

A user equipment can further access a PLMN via a base station of a GSM radio access network. Each base station is connected to a BSC of the radio access network. The BSC of a GSM Radio Access Network is further connected via an A-interface to an MSC/VLR of a circuit switched core network or via a Gb interface to an SGSN of a packet switched core network.

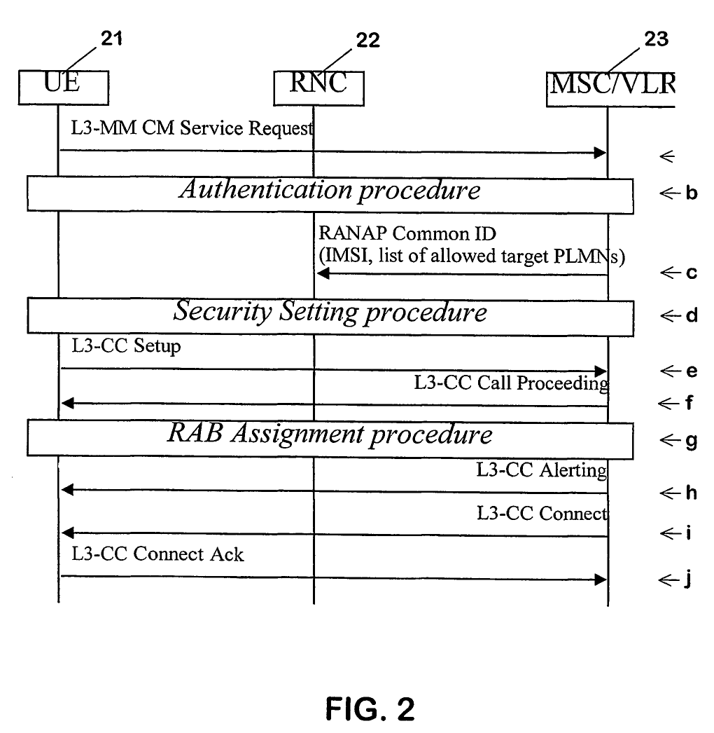

FIG. 2 shows the signalling exchanged for establishing in a mobile communications system a call between a user equipment and a UMTS radio access network in the circuit switched (CS) domain, to which signalling information according to the invention is added.

On the left hand side of the figure, a user equipment 21 is represented. In the middle of the figure, an RNC 22 of a UMTS radio access network is represented. On the right hand side of the figure, an MSC/VRL 23 of a core network to which the RNC 22 is connected, is represented. Arrows and rectangles connecting the units indicate the signalling between them in steps a) to j).

The user equipment 21 is presently not connected to any radio access network, but now it is to be connected to the RNC 22. It is subscribed to an MVNO which has an agreement with the network operator of the PLMN to which the RNC 22 belongs, and equally with some other network operators. This agreement allows the user equipment 21 to access the radio access network of the RNC 22 and specified other radio access networks belonging to one of said network operators. This corresponds to the situation of the second user equipment 15 depicted in FIG. 1, which is subscribed to an MVNO and allowed to access the first radio access network 11 of a first network operator A and a third radio access network 13 of a second network operator B.

The RNC 22 has presently no information about the radio access networks to which the user equipment 21 is allowed to be handed over in case a handover becomes necessary at some point of time after the connection has been established.

The MSC/VLR 23, in contrast, comprises storing means into which the operator of the network has stored a list for each of several user equipments, or for each of different groups of user equipments, subscribed with MVNOs having an agreement of sharing network resources with the network operator. The respective list includes MCC/MNC pairs which identify all radio access networks to which the respective user equipment can be handed over according to the agreement between the network operator and the MVNO.

Most of the signalling depicted in FIG. 2 corresponds to the signalling specified in the technical specifications 3GPP TS 24.008 V3.6.0: “3rd Generation Partnership Project; Technical Specification Group Core Network; Mobile radio interface layer 3 specification; Core Network Protocols—Stage 3”, e.g. Release 1999, and 3GPP TS 25.413 V3.4.0: “3rd Generation Partnership Project; Technical Specification Group Radio Access Network; UTRAN Iu Interface RANAP Signalling”, e.g. Release 1999.

In accordance with these standards, a L3-MM (layer 3 mobility management) CM (Connection Management) Service Request is transmitted in a first step a) from the mobile station 21 via the RNC 22 to the MSC/VLR 23. This message is sent by the mobile station to the network to request a service for connection management sublayer entities, e.g. circuit switched connection establishment, supplementary services activation, short message transfer and location services. In a next step b), an authentication procedure is carried out for authenticating the mobile station 21. In a further step c), a RANAP (Radio Access Network Application Part) Common ID (Identity) message is transmitted from the MSC/VLR 23 to the RNC 22. This message supplies the RNC 22 with the Common ID of the mobile station 21, i.e. with the permanent NAS (Non Access Stratum) identity of the mobile station 21. Additionally, the Common ID message carries the list of allowed target PLMN for the particular user equipment. A security setting procedure follows in step d). The purpose of this procedure is to allow the core network to pass cipher and integrity mode information to the UMTS radio access network. The radio access network uses this information to select and load the encryption device for user and signalling data with the appropriate parameters, and also to store the appropriate parameters for the integrity algorithm. Step e) is used for transmitting a L3-CC (call control) Setup signalling from the mobile station 21 via the RNC 22 to the MSC/VLR 23. The setup message contains all the information required by the network to process the call, like the called party address information. A transmission in the opposite direction in step f) carries a L3-CC Call proceeding to indicate that the call is being processed. With step g) follows a RAB (Radio Access Bearer) assignment procedure. The purpose of the RAB Assignment procedure is to establish new RABs and/or to enable modifications and/or releases of already established RABs for a given user equipment. Steps h) and i) include alternative transmissions from the MSC/VLR 23 via the RNC 22 to the mobile station 21. An L3-CC Alerting signal, step h), on the one hand, indicates that alerting has been started at the called user side. An L3-CC Connect signal, step i), on the other hand, indicates that the call has been accepted at the called user side. An L3-CC Connect signal is finally answered by the mobile station 21, with an L3-CC Connect acknowledged message, which is transmitted via the RNC 22 to the MSC/VLR 23. More details about the relevance of the different signallings and procedures can be taken from the mentioned standards.

In the described embodiment of the invention, and in addition to the signalling described in the standards, the MSC/VLR 23 of the core network sends the list of allowed target radio access networks stored for the user equipment 21 to the RNC 22 during the call establishment, and more particularly in the RANAP Common ID message of step c). In addition to the list, the IMSI of the user equipment 21 is transmitted.

The RNC 22 stores the received list together with the IMSI of the user equipment 21 and deletes this list only after the user equipment 21 is disconnected from the RNC 22. The RNC 22 therefore knows for a possible handover of the user equipment 21 the potential target radio access networks.

The RANAP Common ID message can be sent at any time after the IMSI of the subscriber becomes known to the core network. Typically it is sent as depicted in FIG. 2 after the subscriber authentication has been successfully executed.

The described signalling can also be employed in the UMTS packet switched PS domain. However, for this case, lists of allowed target radio access networks should be stored in a SGSN, since a UMTS radio access network is connected via an Iu interface to an SGSN of the packet switched core network. The signalling for the UMTS packet domain is specified in the same standards as for the circuit switched domain.

In a UMTS radio access network, lists of allowed target radio access networks can be sent to the RNC 22 as well at a later point of time when the connection with the user equipment 21 has already been established, in particular in an RANAP relocation request, which is sent by the core network to request the target RNC to allocate necessary resources for a relocation.

In order to be able to provide lists of allowed target radio access networks to a circuit switched GSM radio access network, such lists should be stored again in an MSC/VLR, as the GSM BSC of the GSM radio access network is connected via an A-interface to an MSC/VLR of the core network. A selected user equipment specific list can then be included during a call establishment in a BSSMAP (Base Station Subsystem Application Part) Common ID message to the GSM BSC. Similar to the RANAP Common ID message for UMTS, the BSSMAP Common ID message is transmitted to inform the BSC about the IMSI of a user. In this case, the security setting and assignment procedures are not specified in one of the above mentioned standards, but in the technical specification 3GPP TS 48.008V4.2.0: “3rd Generation Partnership Project; Technical Specification Group GSM EDGE Radio Access Network; Mobile-services Switching Centre—Base Station System (MSC—BSS) interface; Layer 3 specification”, e.g. Release 2000.

In the GSM 2G PS domain, the GSM BSC of a GSM radio access network is connected via a Gb interface again to an SGSN. Therefore, also for this option, lists of allowed target radio access networks should be stored in an SGSN. A user equipment specific list can then be included in the DL (Downlink)-UNIDATA message, which contains information elements on the downlink, or in a BSS-CREATE-PFC (Packet Flow Context) message from the SGSN to the GSM BSC using the Gb interface. The BSS-CREATE-PFC message allows the SGSN to request that a BSS create or modify a BSS Packet Flow Context. The signalling between the SGSN and BSC for the establishment of a session is specified for the GSM PS domain in the technical specification 3GPP TS 48.018 V4.0.0: “3rd Generation Partnership Project; Technical Specification Group GSM EDGE Radio Access Network; General Packet Radio Service (GPRS); Base Station System (BSS)—Serving GPRS Support Node (SGSN); BSS GPRS Protocol (BSSGP)”, e.g. Release 2000.

Also in GSM, the list can be transmitted at a later point of time to a GSM BSC, in particular in a BSSMAP Handover Request message, which is sent from an MSC to a BSS to indicate that the user equipment is to be handed over to that BSS.

As consequence of the different possibilities of access for a user equipment to a PLMN, all SGSNs and MSC/VLRs of the PLMN should be provided with lists indicating for selected user equipment to which radio access networks they are allowed to be handed over. Only then successful handovers are enabled in a comprehensive way.

The transmission of a list is only an option for the core network. Whether the list is actually sent to the RNC is at the discretion of the core network.

1. Method for supporting a handover of a user equipment (15) from a first radio access network (11) to a second radio access network (13), wherein a core network to which the first radio access network (11) is connected transmits information stored in said core network to said first radio access network (11), which information indicates to which radio access networks (13) the user equipment (15) is permitted to be handed over.

2. Method according to claim 1, wherein said information is transmitted from said core network to said first radio access network (11) during an establishment of a connection (c) between said user equipment (15) and said core network via said first radio access network (11).

3. Method according to claim 2, wherein said information is transmitted from said core network to said first radio access network (11) after an authentication (b) of said user equipment (15) with said core network.

4. Method according to one of the preceding claims, wherein said information is transmitted from said core network to first radio access network (11) to a second network element of said first radio access network (11).

5. Method according to one of the preceding claims, wherein said information transmitted from said core network to said first radio access network (11) comprises the MCC (mobile country code) and MNC (mobile network code) of each radio access network (13) to which said user equipment (15) is permitted to be handed over.

6. Method according to one of the preceding claims, wherein said information transmitted from said core network to said first radio access network (11) is provided to said core network by the operator of a mobile communications network to which said core network belongs.

7. Method according to one of the preceding claims, wherein the core network determines, whether information is to be transmitted or not for a specific user equipment (15).

8. Method according to one of the preceding claims, wherein said information transmitted from said core network to said first radio access network (11) indicates in which order the radio access networks (11,13) to which a handover by said user equipment (15) is allowed are preferably selected for a handover by said first radio access network (11).

9. Method according to one of the preceding claims, wherein said user equipment (15) is subscribed to a mobile virtual network operator.

10. Core network of a mobile communications system comprising storing means for storing for at least one user equipment or for at least one group of user equipments information indicating to which radio access networks (11,13) a respective user equipment (15) is permitted to be handed over, and transmitting means for transmitting said information stored for a specific user equipment (15) or for a specific group of user equipments to a radio access network (11) to which said specific user equipment (15) or a member of said specific group of user equipments is currently connected or to which said specific user equipment (15) or said member of said specific group of user equipments is currently establishing a connection.

11. Network element for a core network of a mobile communications system comprising storing means for storing for at least one user equipment or for at least one group of user equipments information indicating to which radio access networks (11,13) a respective user equipment (15) is permitted to be handed over, and transmitting means for transmitting said information stored for a specific user equipment (15) or for a specific group of user equipments to a radio access network (11) to which said specific user equipment (15) or a member of said specific group of user equipments is currently connected or to which said specific user equipment (15) or said member of said specific group of user equipments is currently establishing a connection.

12. Network element according to claim 11, characterised by being an SGSN (Serving General Packet Radio System Support Node).

13. Network element according to claim 11, characterised by being an MSC/VLR (Mobile Services Switching Centre / Visitor Location Register) or an MSC server.

14. Network element for a radio access network (11) of a mobile communications system comprising receiving means for receiving information indicating for a user equipment (15) currently connected to said network element or currently establishing a connection to said network element to which radio access networks (11,13) said user equipment (15) is permitted to be handed over, and selecting means for selecting a network element of another radio access network (15) for a handover of said user equipment (15) to a network element of another radio access network according to information received by said receiving means for said user equipment (15).

15. Network element according to claim 14, characterised by being an UMTS RNC (Universal Mobile Telecommunications System Radio Network Controller) 16. Network element according to claim 14, characterised by being a GSM BSC (Global System for Mobile Communications Base Station Controller).
